(19) United States
(12) Patent Application Publication
(10) Pub. No.: US 2020/0254604 A1
(43) Pub. Date: Aug. 13, 2020

(54) Mobile and Reconfigurable Storage Container Device

(71) Applicant: Daryl Adams, Collegeville, PA (US)

(72) Inventor: Daryl Adams, Collegeville, PA (US)

(21) Appl. No.: 16/781,300

(22) Filed: Feb. 4, 2020

Related U.S. Application Data
(60) Provisional application No. 62/803,389, filed on Feb. 8, 2019.

(51) Int. Cl. B25H 3/02; A47B 88/407; A47B 67/04

(52) U.S. Cl. CPC B25H 3/028; A47B 88/407; A47B 2220/0002; A47B 2220/0061; A47B 2220/008; A47B 67/04

(57) ABSTRACT

A transparent or translucent multi-tiered and reconfigurable mobile storage compartment device for storing and transporting various items in an orderly and efficient manner. The storage compartment device is comprised of a plurality of repositionable work surfaces and arrangeable and reconfigurable drawers with various inserts and dividers. To aid in the transport of the storage compartment device, a plurality of wheels are positioned along the bottom of the device, and a telescoping handle assembly is attached to the side of the device. Further embodiments of the device comprise multiple and rotatable housing portions, additional handles for easily transporting the device and an integrated supply checklist.

### CROSS-REFERENCE TO RELATED APPLICATION

The present application claims priority to and the benefit of U.S. Provisional Application No. 62/803,389 filed on Feb. 8, 2019, which is incorporated herein by reference in its entirety.

### BACKGROUND

The present invention relates generally to a new and improved, multi-tiered organizational storage system that can be used for both indoor and outdoor events, such as barbecues, picnics, tailgating, boating, sporting events, camping and the like. For general storage needs such as holiday decorations, playroom toys & games and the like. More specifically, the invention relates to a mobile storage container comprised of a transparent, translucent or solid color material, and that is further comprised of multiple and customizable drawers and drawer inserts that enable a user to quickly construct a personally tailored configuration for the storage container device and easily store, identify and subsequently access desired items therein or thereon. Accordingly, the present specification makes specific reference thereto. However, it is to be appreciated that aspects of the present invention are also equally amenable to other like applications, devices and methods of manufacture.

When hosting or attending activities such as barbecues, picnics, tailgating, boating, sporting events, camping and the like, a variety of items and supplies are commonly needed. These items may include, without limitation, such things as food items, cooking utensils, cooking ingredients, condiments, place settings, cleaning supplies, first aid items, games, and any number of other items depending upon the particular activity, event or engagement. For a holiday occasion, items such as Christmas balls, tree ornaments, tinsel, Christmas lights, stockings, and candles. Because said items and supplies are needed for such events, there is also a related need for an improved, multi-tiered and mobile organizational storage system to store and transport said items and supplies, and to improve a user's accessibility to the same.

Users commonly store the above referenced items and supplies in any number or different types of containers including, without limitation, boxes, storage bins, totes, bags, and various other devices of the like. For example, an individual may choose to store certain categories or types of items in multiple separate containers depending upon the event or activity, the function/purpose of each item being stored, and the storage space available in the chosen container(s). However, having multiple different containers can be expensive and takes up too much space.

Further, because all items that would be stored in said containers would likely be of importance to the specific event the user is attending or participating in, it is beneficial to have all items stored in one central location for convenience. However, conventional containers like those mentioned above have several inherent drawbacks and limitations. One such inherent limitation or drawback is the limited organizational nature of the particular container type. For example, if a simple box-like container device is used to store a number of items, the user has no way to quickly locate a particular item within the container device or to compartmentalize or separate the items within the container device without having to resort to a secondary means of organizing/dividing the items, such as placing them into a number of separate smaller container devices within the larger container device. Additionally, the use of smaller container devices stored within a larger container device increases expense and may make it more difficult for the user to locate the particular item that the user desires, as the user would most likely have to move several secondary containers around and open the same to locate the desired item within the larger container.

Moreover, as noted above, if the user does not opt to use secondary containers and simply places all items into one large container, the ability to efficiently locate one specific item among many different items is greatly diminished. In addition, any unsecured items within a container device that lacks a lid or other closure mechanism has the ability to be dislodged from its current location, thereby making it more difficult to subsequently locate, and or may result in the loss of the item altogether. Items may also be more prone to breakage or, in the case of a liquid item being stored, a leaky or broken container can potentially destroy part or all items contained within. With personally tailored compartments with said storage container, potential damage to items is reduced as the specific compartment impedes potential widespread contamination and loss of items

To overcome the inherent limitations and inefficiencies associated with the compartmentalization and organization of certain prior art containers, other known containers further comprise fixed sub-dividers or other segmenting or compartmentalizing means that are positioned within the container to segregate or subdivide the interior portion thereof. These compartments allow the user to separate stored items based on any number of factors of preference including, without limitation, the type of item, the function of the item, or any other user selected criteria. However, containers with integrated or fixed dividers or non-modifiable compartments still contain an inherent drawback, namely they are not customizable to suit user need and/or preference in terms of size, position, dimensions, etc. For example, the size or dimensions of a fixed storage space created by a divider or other compartment means may not permit a user to store an oversized item therein, or may result in a user having to store a number of smaller items in an oversized compartment, thereby wasting valuable storage space. To counteract this inefficiency, the user may be forced to store additional items in the underutilized compartment/divider which, in turn, creates the same issue mentioned above, namely having a storage space cluttered with unrelated items that makes it increasingly difficult and time consuming for a user to find any one particular item.

Other prior art storage container devices are opaque in nature, and do not permit a user to easily view the contents of the storage container device itself or the storage compartments contained therein. This lack of visibility can make it difficult for a user to quickly and efficiently locate a particular item stored within the storage container device, particularly if the user didn't place the item in the storage container device in the first place. Further, the use of such opaque storage containers requires the user to search each and every separate compartment for the item, which is inefficient and can be extremely frustrating for the user. Still other prior art storage container devices lack sufficient work space or a work surface for a user once an article or item is successfully retrieved from the storage container device, thereby requiring the user to also provide or locate a nearby work surface.

Additionally, most storage container devices brought to events and other activities have no means of being easily transported or moved other than by being picked up and carried by the user. This drawback is fully realized if the container device contains a large number of items, or the items that are being stored within the container are of substantial weight. If the container is ultimately deemed too heavy to be picked up and carried by the user, the user may resort to dragging the container, which can damage the container itself and further lead to the container breaking open and spilling its contents. Furthermore, many containers that would be used in such circumstances may not have any exterior handles or areas for a user to grip to aid in the moving of the container, thereby making it even more difficult to transport the container. To circumvent the inherent inefficiencies regarding mobility of currently used containers, some known containers are comprised of wheels that allow the user to push the container to a different area. However, many of these wheeled containers lack a means to steer the container or pull the container behind them, such as an extendible handle that may be conveniently located on the container device and stowed when not in use.

Therefore, there exists a long felt need in the art for an improved storage container that is both mobile and relatively easy to transport. There is also a long felt need in the art for an improved storage container that allows the user to readily see the contents of the storage container from any direction and/or angle. Further, there is a long felt need in the art for a storage container comprised of a plurality of compartments and/or removable drawers that are easily reconfigurable to suit user need and/or preference, and that further comprises a plurality of workspaces that are repositionable between a stowed position and a deployed position. Finally, there is a long felt need in the art for an improved storage container that further comprises an integrated supply checklist, and that is relatively safe and easy to transport and use.

In one exemplary embodiment, the present invention discloses a mobile storage container device comprised of a transparent or translucent housing, a plurality of repositionable doors and workspaces attached to said housing, and a plurality of reconfigurable drawers and compartments stored within an interior of said housing. The storage container device of the present invention may further comprise one or more handles including, without limitation, a telescoping handle, and a plurality of wheels with brakes attached to a bottom of the housing for easy transportation of the storage container device. Finally, the device may further comprise an integrated supply checklist for stocking and easily locating items within the storage container device.

The storage container device of the present invention accomplishes all of the forgoing objectives, thereby improving the ability of a user to successfully store and easily identify and access items needed for events such as picnics, barbeques, tailgates, holidays and other events in one centralized and readily movable/transportable location. In addition, the device gains storage area for the user by being comprised of one or more extendable tabletop like work surfaces.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein is a new and improved, multi-tiered organizational storage system that can be used for both indoor and outdoor events, such as barbecues, picnics, tailgating, boating, sporting events, camping, holidays and the like. More specifically, the invention relates to a mobile storage container that, in one exemplary embodiment, is comprised of a transparent or translucent material, multiple and customizable drawers and drawer inserts that enable a user to quickly construct a desired configuration for the storage container device and store, identify and access desired items therein.

The storage container device of the present invention preferably comprises a generally rectangular housing that encloses an interior space for housing a series of removable drawers, with each drawer having a handle that is integrally cut into the drawer face. Additionally, because the improved, multi-tiered organizational storage device is comprised of a transparent or translucent material, a user can easily view the contents being stored within the device from any angle or direction. The storage container device is further comprised of a plurality of wheels with brakes, such as canister wheels, and a retractable telescoping handle assembly that allow the storage container device to be easily transported with minimal effort by the user. Additionally, the storage container device is also comprised of a set of handles attachable or integrated into the sides of the storage container device to allow the device to be easily handled and carried by the user when it is not possible to transport the device via the wheels. Finally, the device features a set of drawer inserts/dividers that allow the user to customize the storage area size/dimensions within each drawer.

In a further preferred embodiment of the present invention, the storage compartment device is further comprised of a work surface or tray member that is repositionable from a stowed position to a deployed position to form a tabletop-like extension for the user, and an integrated and modifiable supply checklist that further enables the user to quickly and efficiently both stock the storage compartment device with desired supplies and items, and subsequently locate the same for use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of one embodiment of the storage container device of the present invention in a partially deployed position, with a telescoping handle assembly located on the front right corner of the storage container device in a deployed position in accordance with the disclosed architecture.

FIG. 2 illustrates a partially exploded view of the storage container device of FIG. 1 in an open or deployed position (with the exception of the telescoping handle assembly, which is in a stowed position) and with the front doors removed to better illustrate the interior portion of the housing and the plurality of removable and reconfigurable drawers contained therein, all in accordance with the disclosed architecture.

FIG. 3 illustrates a perspective view of a portion of the interior of the housing of the storage container device shown in FIG. 2 with additional perspective on the plurality of removable drawers, some of which are comprised of internal customizable and removable inserts and dividers in accordance with the disclosed architecture.

FIG. 4 illustrates a perspective view of the storage container device shown in FIG. 2 in an open or deployed position (with the exception of the telescoping handle assembly, which is in a stowed position) and with the front doors removed to better illustrate the interior portion of the housing and the plurality of removable and reconfigurable drawers contained therein, and positioned next to a user utilizing an outdoor grill at an event in accordance with the disclosed architecture.

FIG. 5 illustrates a front perspective view of the storage container device of FIG. 1 in an open or deployed position (with the exception of the telescoping handle assembly, which is in a stowed position) and with the front doors (also referred to as drawer front panel or drawer front side) opened to better illustrate the interior portion of the housing and the plurality of removable and reconfigurable drawers contained therein, all in accordance with the disclosed architecture.

FIG. 6A illustrates one potential embodiment of a drawer for use with the storage container device of the present invention and having a plurality of slots therein for receipt of dividers, all in accordance with the disclosed architecture.

FIG. 6B illustrates one potential embodiment of length and width dividers for the partitioning of the drawer shown in FIG. 6A, all in accordance with the disclosed architecture.

FIG. 6C illustrates an alternative embodiment of length and width dividers for the partitioning of the drawer shown in FIG. 6A, all in accordance with the disclosed architecture.

FIG. 7A illustrates a perspective view of an alternative embodiment of the storage container device of the present invention in a partially deployed position, wherein a first housing is hingedly attached to, and repositionable about, a second housing to expose an interior of the respective housings in accordance with the disclosed architecture.

FIG. 7B illustrates a rear perspective view of the storage container device of FIG. 7A in accordance with the disclosed architecture.

FIG. 8 illustrates a front perspective view of the storage container device of FIG. 7A in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there is a long felt need in the art for an improved storage container device that: (a) is both mobile and relatively easy to transport; (b) allows users to readily view the contents of the device from any direction and/or angle; (c) is comprised of a plurality of compartments and/or removable drawers that are easily reconfigurable to suit user need and/or preference; (d) is comprised of a plurality of workspaces that are repositionable between a stowed position and a deployed position; (e) is comprised of an integrated supply checklist; and (f) is relatively safe and easy to use.

The storage container device of the present invention accomplishes all of the forgoing needs and objectives, and is designed to allow a user to store any number or type of items that may be brought to a social gathering such as, but not limited to, picnics, barbeques, tailgates, and other events in one centralized location. Generally stated, the storage container device of the present invention is comprised of a substantially transparent or translucent plastic material that allows a user to view the interior of the device and its various compartments from any direction and any angle to easily and efficiently determine where a desired item is located without having to open each drawer and/or compartment individually. The storage container device also permits a user to customize the layout or configuration of each drawer with a series of removable vertical and horizontal inserts/dividers that can be placed in any configuration desired by the user. For ease of transportation, the storage container device is further comprised of a plurality of wheels having brakes, and one or more handles including, without limitation, a retractable telescoping handle. Finally, the storage container device comprises a plurality of worksurfaces that are individually repositionable between a stowed position and a deployed position, and an integrated and user modifiable inventory checklist.

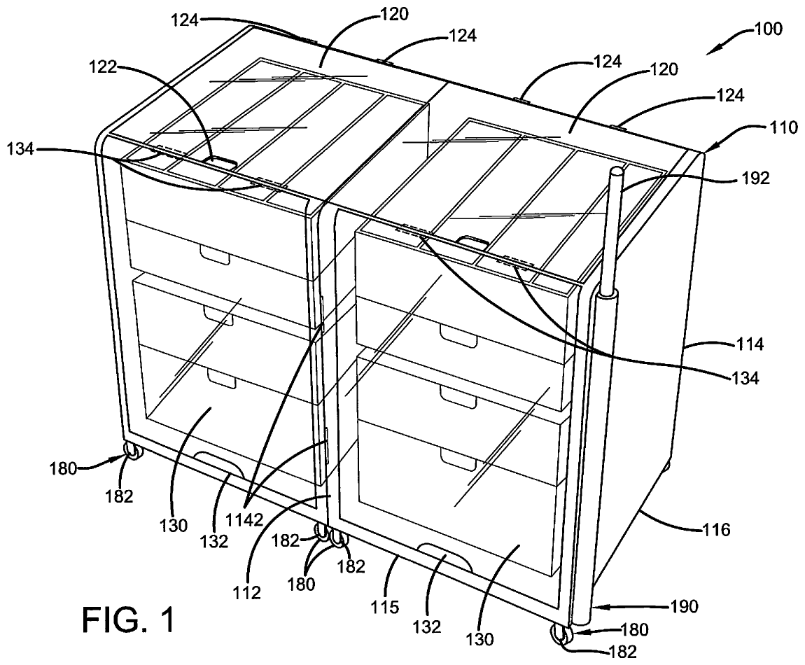

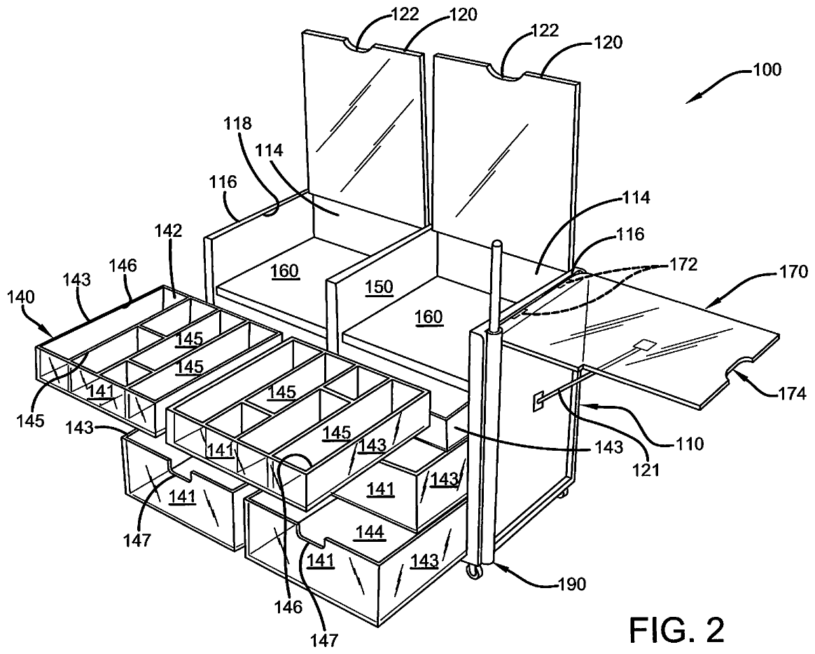

Referring initially to the drawings, FIG. 1 and FIG. 2 illustrates a perspective view of one embodiment of the storage container device 100 of the present invention in a closed position. Storage container device 100 is preferably comprised of a housing 110, one or more top doors 120, one or more front doors 130, a plurality of drawers 140, one or more column dividers 150, one or more shelves 160, a least one repositionable table top 170, at least one repositionable table top support 171, and a plurality of wheels 180 for easily transporting storage container device 100 across a surface, such as a floor, concrete or asphalt parking lot. Unless otherwise stated herein, the various components of storage container device 100 are preferably comprised of a durable and substantially transparent or translucent plastic material such as, but not limited to, Acrylontride-butadiene-styrene (ABS), acrylics, Polyethylene (PE), Polypropylene (PP) or Polyvinyl Chloride (PVC), or the like to enable a user 300 to view the interior of storage container device 100 and its various compartments from any direction and any angle without having to physically access the same. Notwithstanding, it is contemplated that storage container device 100 may also be comprised of other materials without significantly impacting the overall concept of the present invention.

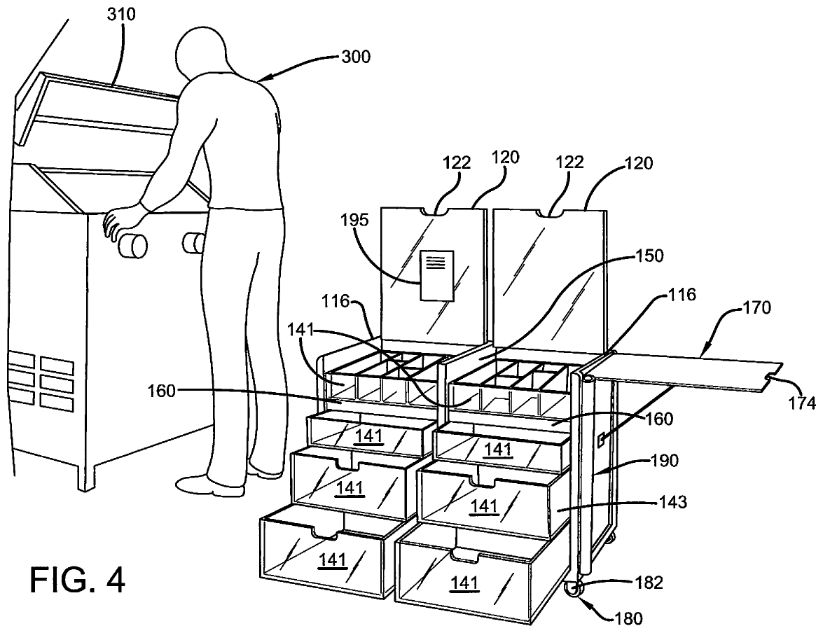

As best shown in FIGS. 1, 2 and 5, housing 110 is generally rectangular in shape and preferably comprised of a front 112, a back 114, a bottom 115, and opposing sides 116 that are attached to and join said front 112, back 114 and bottom 115 to form an interior space 118. Housing 110 may further comprise one or more removable handles 117 attached to the surface of one or more of the front 112, back 114, and/or opposing sides 116 for easy handling. Further, as best shown in FIG. 1, a handle assembly 190 may also be attached to one or more of the front 112, back 114, and/or opposing sides 116 for additional user convenience. Handle assembly 190 may be further comprised of a retractable, telescoping handle 192 that is repositionable between a deployed position, extending outwardly from handle assembly 190 as shown in FIG. 1, and a stowed position within handle assembly 190 as shown in FIG. 4. In a deployed position, telescoping handle 192 allows the user 300 to control (i.e., push or pull) the storage container device 100 via wheels 180, as described more fully below. When not in use, telescoping handle 192 retracts fully into the handle assembly 190 for, by way of example, transporting the storage container device 100 in a vehicle.

In a preferred embodiment of the present invention, the dimensions of the housing 110 are as follows: (a) between 36 and 40 inches wide, as measured between opposing sides 116; (b) between 12 and 14 inches deep, as measured between front 112 and back 114; and (c) between 28 and 32 inches high, as measured from bottom 115 to the upper surface of the top doors 120, though it is contemplated that other shapes and dimensions could also be used without significantly impacting the overall concept of the present invention.

As best shown in FIGS. 1, 2, 4 and 5, storage container device 100 preferably comprises two top doors 120 that are hingedly attached to the back 114 of housing 110 via one or more hinges 124, and that operate independently of one another. More specifically, each of said top doors 120 may further comprise an integrated handle portion 122 that may be utilized by user 300 to reposition the top doors 120 from a closed position (as best illustrated in FIG. 1) to an open position (as illustrated in FIGS. 2 and 4), thereby permitting the user 300 to access items or articles 200 stored in the interior 118 of storage container device 100. Further, the top doors 120 also function as workspace for user 300 to, for example, prepare foods to be cooked on a grill 310, as best shown in FIG. 4. Notwithstanding, it is also contemplated that storage container device 100 may have a single top door 120 or more than two top doors 120 that function in the same manner, or that the top doors 120 may be hingedly attached to column divider 150 or opposing sides 116 and open sideways to expose the interior 118.

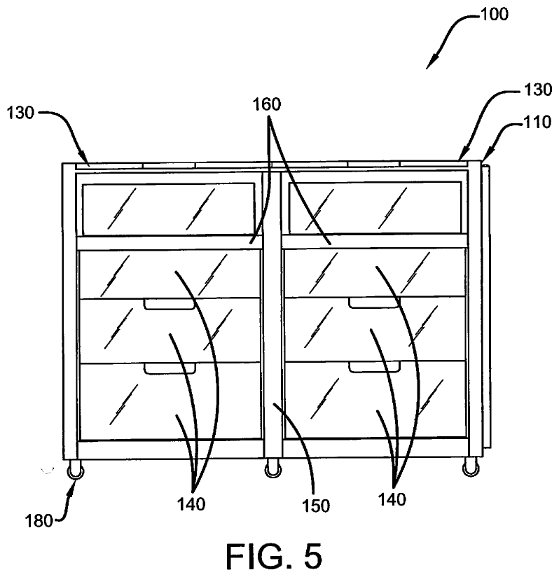

As best shown in FIGS. 1 and 5, storage container device 100 preferably comprises two front doors (a/k/a drawer front panel or drawer front side) 130 that are hingedly attached to the sides 116 of housing 110 via one or more hinges 134, and that operate independently of one another. More specifically, each of said front doors 130 may further comprise an integrated handle portion 132 that may be utilized by user 300 to reposition the front doors 130 from a closed position (as best illustrated in FIG. 1) to an open position (as best illustrated in FIG. 5), thereby permitting the user 300 to access items or articles 200 stored in the interior 118 of storage container device 100. Further, the front doors 130 also function to retain the various drawers 140 within the interior 118 of storage container device 100 when not need and/or during transportation of the device. Notwithstanding, it is also contemplated that storage container device 100 may have a single front door 130 or more than two front doors 130 that function in the same manner, or that the front doors 120 may be hingedly attached to housing 110 so that they open by lifting the front door(s) 130 in an upward manner.

As best shown in FIGS. 2 through 4, each of the plurality of drawers 140 is generally rectangular in shape and preferably comprised of a front 141, a back 142, a bottom 144, and opposing sides 143 that are attached to and join said front 141, back 142 and bottom 144 to form an interior compartment 146 for storing articles 200 such as food items, cooking utensils, cooking ingredients, condiments, place settings, cleaning supplies, first aid items, games, and the like. Each of said plurality of drawers 140 may further comprise a removable or integral handle 147 attached to or formed in the surface of front 141 for easy handling or repositioning of said drawers 140.

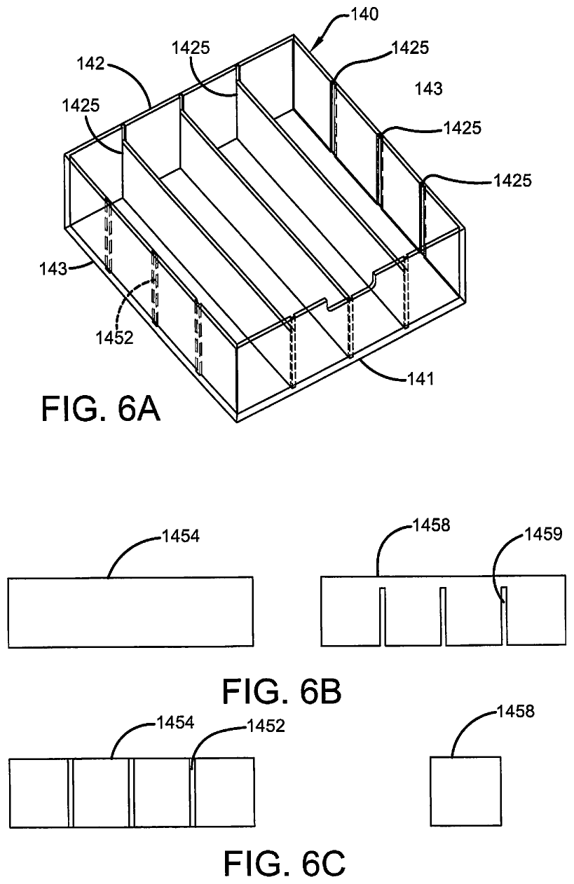

Further, each of said plurality of drawers 140 may further comprise one or more removable dividers 145 for compartmentalizing or segmenting the compartments 146 of said drawers 140, as best shown in FIGS. 2, 3 and 4. The height of said dividers 145 would typically be less than the overall height of the sides 143 of the drawers 140, so as to not interfere with the housing 110 or the other drawers 140, as the drawer 140 is being repositioned by user 300. As best shown in FIGS. 6A through 6C, dividers 145 may come in many different embodiments. For example, dividers 145 may easily slip into a divider channel 1452 formed in or extending from any of front 141, back 142, bottom 144, and/or opposing sides 143. Further, dividers may be further categorized as length dividers 1454 or width dividers 1458, as best shown in FIGS. 6B and 6C. More specifically, the width dividers of FIG. 6B may further comprise one or more partial slots 1459 formed therein for mating engagement with length divider 1454 or vice versa. Alternatively, and as best shown in FIG. 6C, width divider 1458 or length divider 1454 may also comprise one or more divider channels 1452 formed therein for mating engagement with the other respective one of width divider 1458 or length divider 1454.

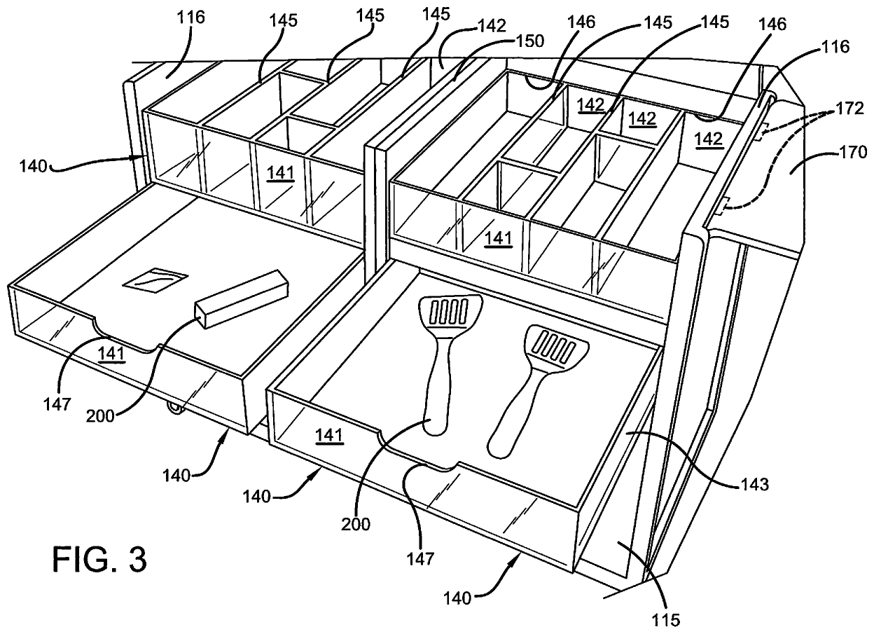

The drawers 140 may be positioned within the interior 118 of the housing 110 in any manner that suits a user's need or preference. Further, as best shown in FIGS. 2-4, housing 110 may further comprise one or more column dividers 150 and/or shelves 160 removable attached to the housing 110 to further allow the user 300 to configure the interior 118 of the housing 110 in any desired manner. For example, a drawer 140 may be positioned on shelf 160 on each side of column divider 150, as best shown in FIG. 3, or a plurality of drawers 140 may be stacked on top of one another, as best shown in FIGS. 4 and 5. It is also contemplated that one or more of drawers 140 could be on a slidable track system (not shown), thereby allowing a user 300 to slide the drawer 140 out of the interior 118 of housing 110 to easily locate and retrieve an item 200, and then slide the drawer 140 back into the housing 110.

As noted above and best shown in FIGS. 2 through 4, storage container device 100 further comprises one or more repositionable table tops or work surfaces 170. For example, a repositionable table top 170 may be attached to one or both of opposing sides 116 of housing 110 via one or more hinges 172, as best shown in FIG. 2. Additionally, table tops 170 are easily repositionable between a stowed position, as best shown in FIGS. 1 and 5, and a deployed position, as best shown in FIGS. 2 through 4. Repositionable table top 170 may further comprise a removable or integrated handle 174 to enable a user 300 to easily reposition table top 170 from the stored position to the deployed position, for example, to support or store additional food items, condiments, supplies or any other useful articles, and at least one repositionable table top support 171 that may, for example, extend from side 116 to table top 170, as best shown in FIG. 2.

As previously mentioned, storage container device 100 further comprises a plurality of wheels 180 for easily transporting storage container device 100 across a surface. Wheels 180 may be any type of wheel commonly known in the art for moving or transporting an item, such as cannister or caster wheels, and further comprises a brake 182. Wheels 180 are preferably attached to the underside of bottom 115 in spaced apart fashion and to provide increased stability to storage container device 100.

FIG. 4 illustrates a perspective view of the storage container device shown in FIG. 2 in an open or deployed position (with the exception of the telescoping handle assembly 190, which is in a stowed position) and with the front doors 130 removed to better illustrate the interior 118 of housing 110 and the plurality of removable and reconfigurable drawers 140 contained therein, and positioned next to a user 300 utilizing an outdoor grill 310.

As previously stated, storage container device 100 further comprises an integrated and modifiable supply checklist 195 that further enables the user 300 to quickly and efficiently check supply inventory, stock the storage compartment device with desired supplies and items, and subsequently locate the same for use. For example, and as best shown in FIG. 4, supply checklist 195 may be a laminated pre-printed list, an erasable whiteboard or chalkboard removably attached to the underside of one of top doors 120 for convenient access by the user 300. Nonetheless, it is also contemplated that supply checklist 195 can be removable attached to other portions of storage container device 100 including, without limitation, housing 110, front doors 130, repositionable table top 170 etc., or can be a separate and stand-alone device.

FIG. 5 illustrates a front perspective view of the storage container device of FIG. 1 in an open or deployed position (with the exception of the telescoping handle assembly 190, which is in a stowed position) and with the front doors 130 opened to better illustrate the interior 118 of the housing 110 and the plurality of removable and reconfigurable drawers 140 contained therein.

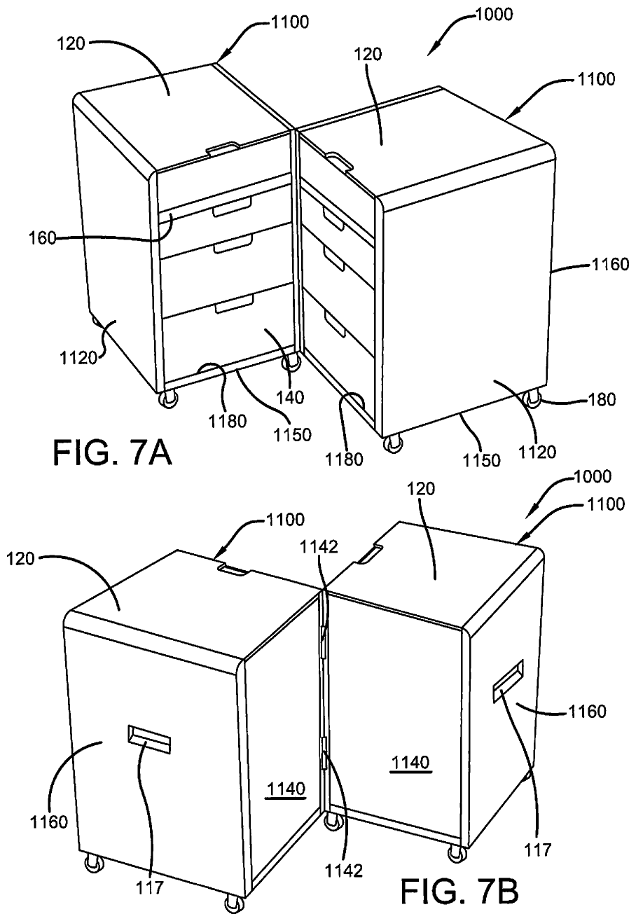

FIG. 7A illustrates a perspective view of an alternative embodiment of the storage container device 1000 of the present invention in a partially deployed position, wherein a first housing 1100 is hingedly attached to, and repositionable about, a second identical housing 1100 via a pair of hinges 1142 to expose an interior 1180 of the respective housings 1100 in accordance with the disclosed architecture. More specifically, housings 1100 are very similar in nature to housing 110 in the embodiment described above and are comprised of a front 1120 (that becomes a side when the storage container device 1000 is fully deployed), a back 1140, a bottom 1150, a pair of opposing sides 1160 (that become the back when the storage container device 1000 is fully deployed) and an interior 1180. As with storage container device 100 described above, the various components of each of housings 1000 may be manufactured from a translucent or transparent material, and the housings may further comprise a plurality of drawers 140, one or more column dividers 150, one or more shelves 160, a plurality of wheels 180 positioned along the bottom 1150, a telescoping handle assembly 190, and an integrated supply checklist 195.

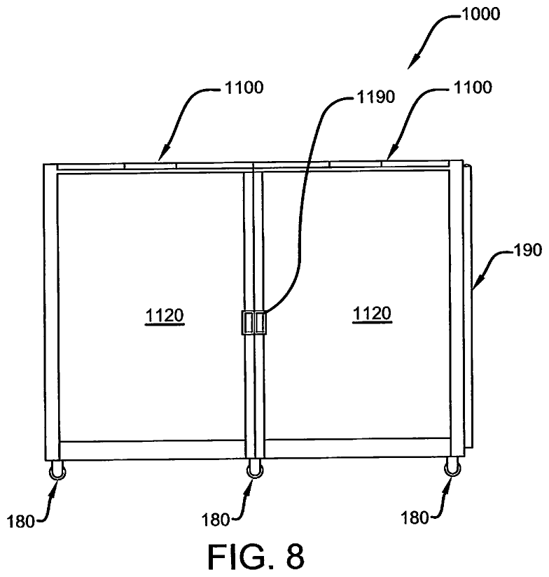

FIG. 7B illustrates a rear perspective view of the storage container device 1000 of FIG. 7A in accordance with the disclosed architecture. The primary differences between storage container device 1000 and storage container device 100 described supra include, but are not limited to: (a) the presence of two separate housings 1100 hingedly attached to, and partially rotatable about, one another (as opposed to a single housing) to expose the interiors 1180 of the respective housings 1000; (b) the orientation of the drawers 140 and shelving 160 of each respective housing 1100 essentially facing each other when storage container device 1000 is in the closed position, as opposed to being substantially side by side and outwardly facing in storage container device 100; and (c) one or more of the front panels 1120 of storage container device 1000 essentially becoming and functioning as the repositionable table top 170 of storage container device 100 and being similarly supported by support 171. Additionally, one or more handles 117 may be conveniently spaced along housings 1100 for easy handling of storage container device 1000 and, as mentioned above, the top doors 120 (and their associated hinges 124) may be configured in any manner to suit user preference or need. For example, with respect to storage container device 1000, top doors 120 may be configured to open front to back, or side to side when device 1000 is in a closed or a deployed position. FIG. 8 illustrates a front perspective view of the storage container device 1000 of FIG. 7A, which may further comprise one or more latches 1190 that enable a user to secure front panels 1120 in a locked fashion and prevent storage container device 1000 from prematurely opening and discharging its contents.

Notwithstanding any of the forgoing, the storage container devices 100 and 1000 can by any suitable size, shape, and configuration as is known in the art without affecting the overall concept of the invention, provided that it accomplishes the above stated objectives. One of ordinary skill in the art will appreciate that the shape and size of the storage container devices 100 and 1000 and their various components, as show in the FIGS. are for illustrative purposes only, and that many other shapes and sizes of the storage container devices 100, 1000 are well within the scope of the present disclosure. Although dimensions of the storage container devices 100, 1000 and its components (i.e., length, width, and height) are important design parameters for good performance, the storage container device 100, 1000 and its various components including drawers 140 may be any shape or size that ensures optimal performance during use and/or that suits user need and/or preference. The storage container devices 100, 1000 can also be used in any application where a user may need to store items, and is not limited in its use to only activities such as picnics, barbeques, tailgates, and other events.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile storage container device comprising:
a housing;
a plurality of repositionable work surfaces attached to the housing;
a plurality of drawers positionable within the housing; and
a plurality of wheels attached to the housing.

2. The mobile storage container device of claim 1, wherein at least one of the plurality of drawers is comprised of a plurality or reconfigurable dividers.

3. The mobile storage container device of claim 1, wherein the housing is comprised of a transparent material.

4. The mobile storage container device of claim 1, wherein the housing is comprised of a translucent material.

5. The mobile storage container device of claim 1 further comprising a telescoping handle attached to said housing.

6. The mobile storage container device of claim 1 further comprising a column divider and at least one repositionable shelf.

7. The mobile storage container device of claim 1 further comprising an integrated supply checklist.

8. A mobile storage container device comprising:
a housing having an interior;
a pair of top doors attached to a top of the housing and providing access to the interior;
a pair of front doors attached to a front of the housing and providing access to the interior;
a plurality of drawers positionable within the interior of the housing; and
a plurality of wheels attached to the housing.

9. The mobile storage container device of claim 8, wherein at least one of the plurality of drawers is comprised of a plurality or reconfigurable dividers.

10. The mobile storage container device of claim 8 further comprising a work space repositionable between a stowed position and a deployed position.

11. The mobile storage container device of claim 8, wherein the housing is comprised of a transparent material.

12. The mobile storage container device of claim 8, wherein the housing is comprised of a translucent material.

13. The mobile storage container device of claim 8 further comprising a telescoping handle attached to said housing.

14. The mobile storage container device of claim 8 further comprising a column divider and at least one repositionable shelf.

15. The mobile storage container device of claim 8 further comprising an integrated supply checklist.

16. A mobile storage container device comprising:
a first housing having a first interior;
a second housing having a second interior and hingedly. attached to said first housing;
at least one repositionable table top movably attached to said first housing or said second housing;
a plurality of drawers positionable within the first interior or the second interior;
a plurality of wheels attached to each of the first housing and the second housing, wherein at least one of said plurality of wheels has a brake; and
a telescoping handle attached to the storage container device, wherein the first interior and the second interior are accessible when the first housing is rotated about the second housing.

17. The mobile storage container device of claim 16, wherein at least one of the plurality of drawers is comprised of a plurality or reconfigurable dividers.

18. The mobile storage container device of claim 16 further comprising an integrated supply checklist.

19. The mobile storage container device of claim 16, wherein the first housing is comprised of a transparent material.

20. The mobile storage container device of claim 16, wherein the first housing is comprised of a translucent material.
